(19) United States
(12) Patent Application Publication
(10) Pub. No.: US 2025/0382873 A1
(43) Pub. Date: Dec. 18, 2025

(54) FLOW METERING DEVICES, SYSTEMS, AND METHODS

(71) Applicant: VMC Patent Inc., GRANDE PRAIRIE (CA)

(72) Inventor: Michael Beck, Grande Prairie (CA)

(21) Appl. No.: 19/095,816

(22) Filed: Mar. 31, 2025

Related U.S. Application Data
(60) Provisional application No. 63/659,078, filed on Jun. 12, 2024.

(51) Int. Cl. E21B 47/103; E21B 47/07; G01F 1/68

(52) U.S. Cl. CPC E21B 47/103; E21B 47/07; G01F 1/68

(57) ABSTRACT

A method of quantifying emissions concentrations emitted from a gas source via a flow path at which a sensor assembly is arranged, the method comprising: obtaining temperature data and pressure data corresponding to a gas emitted by the gas source, obtaining indicia of whether there has been a barometric change at either the gas source or the sensor assembly, adjusting, if there is a barometric change, the pressure data to account for the barometric change, and determining a flow rate of gas emitted by the gas source, a proportion of an emissions present in the gas emitted from the gas source, and a flow rate or volume of the emissions being released based on the pressure data and the temperature data.

### CROSS-REFERENCE TO RELATED APPLICATIONS

The present application claims priority to U.S. Provisional Application No. 63/659,078, filed Jun. 12, 2024, the disclosure of which is being expressly incorporated herein by reference.

### TECHNICAL FIELD

The present disclosure relates to systems or methods for measuring venting, e.g., from a gas or oil well, glycol dehydrator tower, compressor seal, pneumatic control, or solution gas tank.

### BACKGROUND

Orphaned wells refer to oil or gas wells that were once actively producing, but have since been abandoned by their owners and operators. These wells are often left unplugged and uncapped, which can lead to serious environmental and safety hazards, such as soil and water contamination, methane emissions, and even explosions. To address this issue, various technologies have been developed to locate and plug these orphaned wells.

One common method is to use electromagnetic surveys to detect the presence of metal well casings or other underground infrastructure associated with the wells. Once located, specialized crews can then drill down to the well and plug it with cement or other materials to prevent any leakage or environmental damage. Additionally, some companies are developing advanced technologies such as drones and satellite imaging to locate and monitor orphaned wells, which could help reduce the risks associated with these abandoned sites more efficiently.

Methane (CH4) is the main constituent of natural gas, and is widely recognized as a major greenhouse gas, i.e., a gas the emission of which contributes to the gradual increase in surface temperatures of the earth described as global warming. Regulators have an interest in reducing the amount of methane discharged into the environment.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In example 1, a method of quantifying emissions concentrations emitted from a gas source via a flow path at which a sensor assembly is arranged, the method comprising: obtaining temperature data and pressure data corresponding to a gas emitted by the gas source; obtaining indicia of whether there has been a barometric change at either the gas source or the sensor assembly; adjusting, if there is a barometric change, the pressure data to account for the barometric change; and determining a flow rate of gas emitted by the gas source, a proportion of an emissions present in the gas emitted from the gas source, and a flow rate or volume of the emissions being released based on the pressure data and the temperature data.

In example 2, further to example 1, wherein determining the flow rate or the volume of emissions includes determining both volumetric and mass flow rates.

In example 3, further to example 1, wherein the temperature data includes data corresponding to an absolute temperature at flow conditions and an absolute temperature at standard conditions, and wherein the pressure data includes data corresponding to an absolute pressure at flow conditions, an absolute pressure at standard conditions, and a pressure drop at the gas source.

In example 4, further to example 1, comprising determining a geolocation of the gas source.

In example 5, further to example 4, wherein determining the geolocation of the gas source occurs automatically as part of a gatekeeping measure designed to inhibit geolocation tampering.

In example 6, further to example 4, comprising transmitting the geolocation to be compiled into a database for logging geolocations of at least one of sources and sinks.

In example 7, further to example 1, comprising storing as operational data at least one of the temperature data, the pressure data, the volume, and the flow rate; and facilitating remote access to the operational data via an Application Programming Interface.

In example 8, further to example 1, wherein the quantification occurs in real time.

In example 9, a system for compiling a database of geolocations of sources and sinks, the system being configured to acquire a geolocation of a source or sink as determined by a flow device that is configured to quantify emissions concentrations emitted from a gas source via a flow path, wherein acquiring the geolocation of the sources or the sinks as determined by the flow device acts as part of a gatekeeping measure to inhibit tampering with the geolocation.

In example 10, further to claim 9, wherein the flow device is remote from the system.

In example 11, further to claim 9, wherein the system further comprises a storage to store as operational data that is measured by the flow device at least one of temperature data, pressure data, volume, and flow rates, the system is further configured to facilitate remote access to the operational data via an Application Programming Interface (API).

In example 12, further to claim 11, wherein the API enables connectivity to validate the quantification.

In example 13, further to claim 9, wherein the flow device is configured to quantify the emissions concentrations emitted from a gas source via the flow path while accounting for barometric changes at the flow device.

In example 14, further to claim 9, wherein the quantification occurs in about 140 milliseconds to capture low-end bubble flow.

In example 15, a flow device for portably quantifying emissions concentrations in a gas flow at a source, the flow device comprising: a flow path through which gas is transmitted from the source flows, the flow path including a flow path inlet and a flow path outlet; a sensor assembly configured to measure a temperature at the flow device, a pressure drop between the flow path inlet and the flow path outlet, an absolute pressure at the flow device, and a barometric pressure; and one or more processors in communication with the sensor assembly, the one or more processors configured to: adjust the pressure drop to generate a corrected pressure drop based on the barometric pressure if there has been a barometric change and based on a previous barometric pressure if there has not been a barometric change; calculate a mass flow rate of the gas flow using the temperature, the corrected pressure drop, and the absolute pressure; and quantify an amount of the emissions concentrations in the gas flow as a proportion of the gas flow using the mass flow rate.

In example 16, further to claim 15, wherein the one or more processors is further configured to calculate a volumetric flow rate from a Poiseuille equation using the corrected pressure drop, and wherein the mass flow rate is calculated using the temperature, the volumetric flow rate, and the absolute pressure.

In example 17, further to claim 16, further comprising a storage for storing as operational data determined by the flow device at least one of temperature data, pressure data, volume, the mass flow rate, and the volumetric flow rate, and wherein the one or more processors is further configured to facilitate remote access to the operational data via an Application Programming Interface (API).

In example 18, further to claim 17, wherein the API enables connectivity to validate the quantification and to calculate carbon credits based on the quantification.

In example 19, further to claim 15, wherein the sensor assembly includes a gas chromatography detector arranged upstream of the flow path.

In example 20, further to claim 15, wherein the one or more processors are further configured to: determine, automatically and without user intervention, a geolocation of the source; execute a gatekeeping measure to inhibit geolocation tampering using the geolocation; and compile the geolocation into a database of the flow device for logging geolocations of sources.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example embodiment of a methane monitoring, logging and conversion system according to an example embodiment for use in monitoring wellhead methane emissions.

FIG. 2 shows an example embodiment of a control system for a methane monitoring, logging and conversion system according to an example embodiment.

FIG. 3 shows an example embodiment of a power management system for a methane monitoring, logging and conversion system according to an example embodiment.

FIG. 4 shows a flow diagram of an example embodiment of a process for measuring gas flow rate and methane composition according to an example embodiment.

FIG. 5 shows a flow diagram of an example embodiment of a process for selecting a flow rate range mode based on a detected gas flow rate.

FIG. 6 shows a flow diagram of an example embodiment of a process for measuring and converting methane in different modes according to an example embodiment.

FIG. 7 shows an example embodiment of a methane monitoring, logging and conversion system according to an example embodiment.

FIG. 8 shows an example embodiment of a method for measuring and converting methane according to an example embodiment.

FIG. 9 shows a schematic diagram of a network of collaborative oil and gas transportation modes from production sites to end-users.

FIG. 10 shows a schematic diagram of a flow metering network.

FIG. 11A is a partial flowchart of a method for quantifying emissions concentrations emitted from a gas source.

FIG. 11B is a continuation of the flowchart in FIG. 11A.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In one aspect, a vent gas methane data logger system is provided. The system has a data logging unit and a series of modular wellhead sensors and valves. The system can measure vent gas flow rate and methane composition to produce a totalized methane flow. The system can monitor one or a plurality of wellhead pressure transmitters. In some aspects, the system can measure up to four wellhead pressure transmitters. In some aspects, the data so obtained can be recorded using an on-board data logging hardware unit. In some aspects the data so obtained can be transmitted remotely using a cellphone, satellite or other communications unit. In some aspects, the system is modular, self-powered and communicates with the data logging hardware unit via wired or wireless means, e.g., a wireless transmitter or cable connection. In some aspects, the system is suitable for unattended operation. In some aspects, the system connects to an interface application.

In some aspects, the system is installed on a well to provide surface casing vent flow measurement. In some aspects, the system logs such measurements prior to abandonment of the well. In some aspects, the system is capable of measuring both a low flow rate range and a high flow rate range. In some aspects, the system selects the appropriate measuring flow rate range (e.g., low or high) based on the measured gas flow rate.

In some aspects, the flow meter is a laminar flow meter. In one aspect, an ultra-low-flow laminar flow meter is used to measure surface casing vent flow (SCVF). In some aspects, the laminar flow meter is provided as a pipe-mounted transmitter with an on-board battery and solar panel.

In some aspects, the system provides a vent shut-in function. In some aspects, the shut-in can be activated locally via any appropriate wired or wireless communication mechanism, e.g., Bluetooth. In some aspects, the shut-in can be activated remotely, e.g., via a cellphone or satellite signal, or via a web-based interface.

In some aspects, the system is self-powered using built-in batteries and/or a stand-mounted solar array. In some aspects, the system is not intended to be used with gas wells for which the surface casing vent flow contains hydrogen sulfide (H2S) gas. In some aspects, the system has a mechanism for detecting the presence of hydrogen sulfide gas.

As used herein, a “low flow rate range” means a vent flow (e.g., surface casing vent flow) of approximately 0.03 to 6 m³/day, including any value therebetween e.g., 0.04, 0.05, 0.06, 0.07, 0.08, 0.09, 0.1, 0.2, 0.3, 0.4, 0.5, 0.6, 0.7, 0.8, 0.9, 1, 1.2, 1.4, 1.6, 1.8, 2, 2.5, 3, 3.5, 4, 4.5, 5, or 5.5 m³/day. As used herein, a “high flow rate range” means a vent flow (e.g., surface casing vent flow) of approximately 1.5 to 300 m³/day or more, including any value therebetween e.g., 2, 3, 4, 5, 6, 7, 8, 9, 10, 20, 30, 40, 50, 75, 100, 125, 150, 175, 200, 225, 250 or 375 m³/day or more. In some embodiments, the values may overlap for the low and high flow rate ranges, although in any specific embodiment, the lowest value of the low flow rate range may be selected to be a lower value than the lowest value measured in the high flow rate range.

One source of methane is wellhead venting of conventional oil and gas wells. For example, the Alberta Energy Regulator (AER) in Canada estimates that roughly 19% of methane emissions relating to the operations of the oil and gas industry in the province come from wellhead venting of methane. There are regulations in place to regulate wellhead venting in that province and in other jurisdictions. There is the possibility of further regulations being introduced in the future, for example a fee payable on the amount of methane emitted by an oil or gas well.

Options available for handling the discharge of methane from oil wells vary depending on the amount of methane being discharged. For example, where a sufficiently high level of methane is being released by a well, one option is to burn or “flare” the methane. At lower flow rates of methane, the emitted gas typically cannot be flared, and is instead vented to atmosphere.

When conventional oil wells are depleted, the wellbore must be sealed to ensure that harmful fluids, including methane, are not released into the surrounding environment. A primary concern is to minimize the release of methane into the environment after abandonment of the well.

When a depleted well is plugged, it is allowed to settle and off-gas for up to two months. At that time, the surface casing vent flow (SCVF) is tested. If there is no flow, the well can be cut-and-capped and abandoned. If surface casing vent flow (SCVF) is detected, the stabilized flow rate and stabilized shut-in pressure are recorded. The surface casing vent flow (SCVF) and stabilized shut-in pressure are obtained by shutting in the vent, allowing pressure to build and stabilize in the wellhead. The values of these parameters are used to determine whether the surface casing vent flow (SCVF) is serious or non-serious. If there is no flow, then the well can be cut, capped and buried.

After a wellhead shut-in pressure test, the vent pressure must be reduced prior to resuming flow measurement in order to prevent a pressure surge at the flow meter. Typically, a bleed valve is opened to bleed off the accumulated pressure to atmosphere.

Currently (according to AER directive 20) to identify wellhead venting, a hose is connected to the well, inserted into water, and the formation of bubbles is counted. If bubbles are observed, then an analog positive displacement meter or orifice meter may be used to measure the surface casing vent flow.

Positive displacement and orifice plate meters are commonly used to measure the flow of various oil and gas venting. Gas flow rates during wellhead venting can be very low. Conventional flow measurement technologies such as positive displacement and orifice meters are not designed to measure such low flow rates and can provide poor accuracy. Further, many well sites are located in remote areas and do not have access to amenities such as power.

Methane is also discharged in other contexts where it can be important to quantify the amount of methane being released and/or convert the released methane to a different compound. Examples of such contexts include glycol dehydrator towers, compressor seals, pneumatic controls, and solution gas tanks.

For example, glycol dehydrators are used to remove water from natural gas streams to prevent the formation of hydrates and corrosion in pipelines. In a glycol dehydrator tower, wet gas enters the tower and bubbles up through a lean glycol composition that absorbs moisture from the natural gas stream. The glycol can also absorb small amounts of methane and other hydrocarbons as part of this process, which can result in the generation of methane emissions when the glycol is regenerated.

Compressors are widely used in the oil and gas sector, for example to compress natural gas at various stages of transmission and processing. Compressor seals are provided for example as part of a reciprocating compressor rod. Over time, valves or other components of the compressor seal wear and this can result in the release of methane.

Oil and gas sites are often at remote locations and may not have access to power. Gas pressure from a well can be used to operate valves or other pneumatic controls at the site. When these valves or controls are used or opened, they may release gas, including methane.

Oil pumpjacks are used to pump emulsion into solution gas tanks. As oil enters the tank, a gas solution (including methane) is released and vented from the tank. The solution gas can rise to the top of the tank due to gravity because of the lower density of the solution gas, including methane, as compared to the emulsion that enters the tank.

These and other activities result in the release of methane to atmosphere. There is a general desire for improved apparatus, systems and methods for evaluating and monitoring wellhead venting. There is a general desire for improved apparatus, systems and methods for quantifying the amount of methane present in gases vented through wellhead venting, since the vented gas is not generally composed entirely of methane.

Some embodiments of the present disclosure relate to systems or methods for logging the release of gas, e.g., from a gas or oil well, glycol dehydrator tower, compressor seal, pneumatic control, or solution gas tank. Some embodiments of the present disclosure relate to systems or methods for measuring the release of gas, e.g., from a gas or oil well, glycol dehydrator tower, compressor seal, pneumatic control, or solution gas tank. Some embodiments of the present disclosure relate to systems or methods for converting methane, e.g., released by a gas or oil well, glycol dehydrator tower, compressor seal, pneumatic control, or solution gas tank, to a different compound, for example carbon dioxide.

In one embodiment, an exemplary methane emission data logger includes: a laminar flow meter; a data logger; and a methane sensor to quantify the percentage of methane in the vented gases. In some embodiments, the methane emission data logger further includes a catalyst to convert methane to a different gas, e.g., carbon dioxide. In some embodiments, the methane emission data logger further includes one or more pressure sensors, e.g., two, three, four, five, six, seven, eight, nine, ten or more pressure sensors.

In some embodiments, the system provides a vent shut-in and bleed-off function. These functions can be manually activated locally in some embodiments. These functions can be remotely activated in some embodiments, for example using a web-based interface.

In some embodiments, the system has local switches and indicators to facilitate operator control. In some embodiments, the system has an on-board data log storage with local wireless data log access.

In some embodiments, the flow meter measures the surface casing vent flow, and the methane sensor quantifies the amount of methane present in the flow to yield a determination of methane flow rate and/or a totalized methane flow from the well within a given period of time. In some embodiments, the system provides a determination of annual cumulative venting of methane for a well.

In one embodiment, the system has: a plurality of pressure sensors, a laminar flow meter, a datalogger memory storage with I/O control, a satellite web communication unit, a methane concentration meter, and a web-based interface for client login and control access.

In some aspects when operating within the low flow rate range, the system may measure the flow rate with an accuracy of ±1% of full scale output. In some aspects, when operating within the low flow rate range, the system samples and/or records data at a rate of up to 1 sample per second or less. In some aspects, sampling is conducted every 5 to 10 milliseconds. In some aspects, when operating within the high flow rate range, the system samples and/or records data at a minimum rate of 1 sample per day.

In some aspects, the user interface is provided with status LEDs for indicating power, Bluetooth, communication, or an error.

In some aspects, the system has a built-in battery and charge controller. In some aspects, the system is provided with a solar panel. In some aspects, the system is provided with a tripod-mounted solar panel.

In some aspects, the system or select components of the system are contained within a weather resistant case. In some aspects, the pressure monitor is a modular component that is wellhead mounted with a transmitter, on-board battery and solar panel.

In some aspects, the methane detector is provided as a modular component that is contained within a weather resistant case with an on-board battery and solar panel.

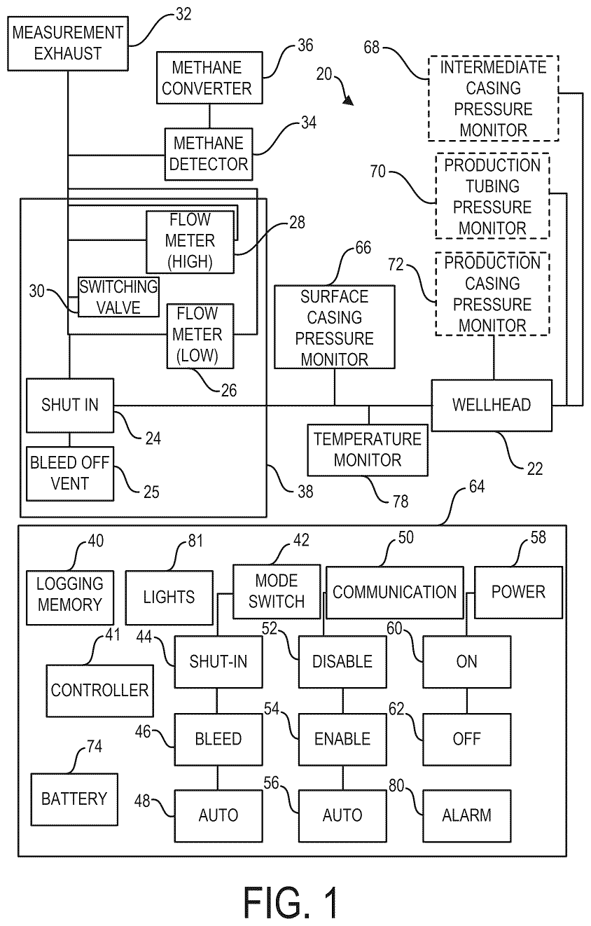

One example embodiment of an emission measuring, logging and conversion system 20 for use at a wellhead is illustrated in FIG. 1. System 20 is used to monitor, record and catalytically convert methane being released from a wellhead 22.

System 20 has a shut-in valve 24 connected to the wellhead 22. In some embodiments, shut-in valve 24 connects to a bleed off vent 25. Shut-in valve 24 can be configured so gases being vented from wellhead 22 pass through a low flow range flow meter 26 or a high flow range flow meter 28, or pass directly to a measurement exhaust 32. A flow meter can be a laminar flow meter, thermal mass flow meter, optical flow meter, ultrasonic flow meter, or other suitable type of flow meter. In some embodiments, low flow range flow meter 26 and high flow range flow meter 28 are the same type of flow meter, e.g., laminar flow meters, and the range of the two flow meters is different. In one example embodiment, both low flow range flow meter 26 and high flow range flow meter 28 have a 200:1 turndown ratio, so that e.g., low flow range flow meter 26 can detect flow rates in the range of 0.03 to 6 m³/day, and high flow range flow meter 28 can detect flow rates in the range of 2 to 300 m³/day, to yield an accurate calibration range of 0.03-300 m³/day of gas flow. In some embodiments, a third flow meter could be used with a different calibration, e.g., in the range of 3 to 600 m³/day, to allow for even higher flow rate sources of gas flow to be measured. In some embodiments, low flow range flow meter 26 and high flow range flow meter 28 record measurements that can be used by system 20 to derive density data related to one or more components or compositions in a gas flow.

A switching valve 30 is provided to regulate the flow of gas through either low flow range flow meter 26 or high flow range flow meter 28. In some embodiments, switching valve 30 is controlled based on a measured flow rate of the gas flowing through shut-in 24, so that gas is directed to low flow range flow meter 26 when the gas flow rate is low or to high flow range flow meter 28 when the gas flow rate is high. In some embodiments, switching valve 30 is a four-way valve. In some embodiments, switching valve 30 can also direct the flow of gas through measurement exhaust 32, to bypass flow meters 26, 28, methane detector 34 and methane converter 36.

In some embodiments, the low flow range flow meter 26 is configured to accurately measure flow rates in the range of 0-2 m³/day. In some embodiments, the high flow range flow meter 28 is configured to accurately measure flow rates in the range of 0-30 m³/day.

When not being directed through bleed-off vent 25, gas flows through either of flow meters 26 or 28 or through a measurement exhaust 32 from which the gas is vented to atmosphere.

In some embodiments, a methane detector 34 is provided to determine the proportion of methane present in the gas being exhausted from system 20. In some embodiments, a methane converter 36 is provided to catalytically convert the methane present in the gas being exhausted to a different compound, to reduce the level of greenhouse gas emissions from wellhead 22, as described in greater detail below. In some embodiments, including the illustrated embodiment, methane detector 34 and/or methane converter 36 are provided on a line separate from measurement exhaust 32, so that gas is only passed through methane detector 34 and/or methane converter 36 when not being vented via measurement exhaust 32. This allows the avoidance of measurement errors, for example as could occur if pressure is built up within the system by shutting in shut-in 24 and then released via measurement exhaust 32.

Although methane detector 34 has been illustrated as being positioned downstream of flow meters 26, 28, in alternative embodiments methane detector 34 could be positioned upstream of flow meters 26, 28, or flow meters 26, 28 could be positioned downstream of methane converter 36. It is important that methane detector 34 be positioned upstream of methane converter 36 where used, as the proportion of methane present in emissions from gas source 22 could not be determined after the methane has been converted to another compound by methane converter 36.

In some embodiments, some or all of shut-in valve 24, bleed off vent 25, low flow range flow meter 26, high flow range flow meter 28 and/or switching valve 30 are contained within a weatherproof enclosure or housing, schematically denoted as 38. Other components could optionally be also provided within weatherproof enclosure 38.

In the illustrated embodiment, system 20 further includes a data logging memory 40. Data logging memory 40 can be used to record various measured parameters relating to wellhead 22 over time, for example a surface casing vent flow rate, the proportion of methane present in the gas being vented from wellhead 22, the surface casing pressure, intermediate casing pressure, production tubing pressure, production casing pressure, and the like. In alternative embodiments, rather than being provided with an on-board data storage unit like data logging memory 40, data could be transmitted by system 20 for storage on a remote data storage system. In some embodiments, data logging memory 40 is a local removable memory such as a USB memory. In some embodiments, data logging memory 40 is a storage unit, for example, providing persistent storage. In some embodiments, the data storage unit 40 is configured to receive data, for example, from another component included in system 20 (e.g., flow meter (high) 28, flow meter (low) 26, surface casing pressure monitor 66, methane detector 34, intermediate casing pressure monitor 68, production tubing pressure monitor 70, production casing pressure monitor 72, temperature monitor 78, a sensor, a monitor, and/or other component).

In some embodiments, system 20 records and/or stores one or more logs in data storage unit 40 (e.g., data logging memory 40). For example, in some embodiments, system 20 receives data relating to errors or to the state of system 20 and/or a component of system 20, including for example the gas flow rate at any given time measured by low flow rate flow meter 26 or high flow rate meter 28 and the corresponding percentage of methane contained in that gas flow as determined by methane detector 34 at that corresponding time. Data logging memory 40 can also store a corresponding timestamp, so that changes in the flow rate and/or methane composition of the gas flow can be monitored and evaluated over time.

System 20 can record and/or store an error counter log and a system state log for each type of error data and/or for a combination of error data, for example. System 20 can process the data received before recording and/or storing the processed data or aspects of it, for example. Examples of the data logged include data relating to, encoding, and/or that can be used to derive same: high pressure, low pressure, high temperature, low temperature, motor stall events, notification(s) from alarm unit 80, system mode (e.g., hand-switch position), time (e.g., time measurement taken), pressure (e.g., surface casing pressure, intermediate casing pressure, production casing pressure), temperature (e.g., enclosure temperature, ambient temperature), gas flow rate, gas flow volume within a predetermined time period, methane percent or amount, battery voltage or battery level, and the like.

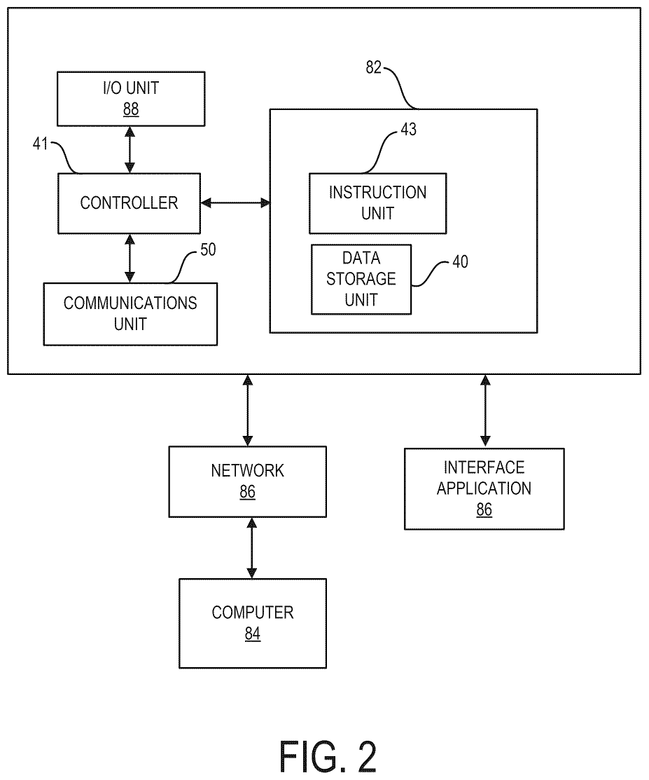

System 20 further includes a controller 41 for controlling the operations of the various data monitoring, recording, communications and power functionalities of system 20. Controller 41 provides an interface for the software used by system 20. In some embodiments, for example, as shown in FIG. 2, controller 41 is a processor configured to execute instructions in an instructions unit 43, for example, in memory, to configure a storage device 82, for example, to perform the functions described herein. In some embodiments, the instructions unit 43 (e.g., memory), is included in a storage device 82 and configured to include a data transmission unit. In some embodiments, the data transmission unit is configured to receive data (e.g., from a data storage unit e.g., data logging memory 40, also referred to as storage unit 40), process the data, and/or transmit the data to another controller 41 included in system 20 and/or to a computer 84 connected to system 20 over a network 86. In some embodiments, system 40 is configured to connect to an interface application 86 directly (for example, via I/O unit 88) or, in some embodiments, over a network 86.

In some embodiments, system 20 further includes controls to allow an operator to regulate the operation of system 20. For example, in the illustrated embodiment, system 20 includes a mode switch control 42, to allow a user to switch between a shut-in mode 44, a bleed mode 46, or an automatic mode 48. In some embodiments, mode switch control 42 is included in an interface application 86, shown in FIG. 2.

In some embodiments, system 20 includes a communications unit 50 that allows for the wired or wireless transmission of data from system 20. In some embodiments, communications unit 50 is a radio communications unit, a Bluetooth communications unit, or other communications unit that uses other protocol(s) and/or other transmission frequencies. In some embodiments, system 20 includes controls that allow a user to disable 52, enable 54 or switch to automatic mode 56 the communication unit 50.

In some embodiments, system 20 includes a power switch 58 that allows a user to turn system 20 on 60 or off 62.

In some embodiments, some or all of data logging memory 40, controller 41, mode switch control 42, communications unit 50 and/or power switch 58 are contained within a weatherproof enclosure or housing, illustrated schematically as 64. In some embodiments, system 20, optionally on housing 64, includes one or more local indicator lights 81 which indicate the mode of operation of system 20, the parameters that system 20 is monitoring, any malfunctions or errors in the operation of system 20, and/or the like.

In some embodiments, system 20 optionally includes one or more pressure sensors, to monitor the pressure at one or more locations. In the illustrated embodiment, a surface casing pressure monitor 66 is provided, to monitor pressure at the surface casing. In some embodiments, a production tubing pressure monitor 68, production casing pressure monitor 70 and/or an intermediate casing pressure monitor 72 are provided as part of system 20 to measure pressure at these locations. In some embodiments, the pressure sensors provided as part of system 20 are not integral to detecting, measuring, logging and/or converting methane, but are useful to meet other regulatory requirements.

In some embodiments, system 20 optionally includes one or more temperature monitors 78. The one or more temperature monitors 78 detect and/or measure temperature at a desired location. For example, in some embodiments, temperature monitor 78 detects and/or measures ambient temperature (e.g., temperature of an enclosure that the data logger can be situated in), temperature within system 20, temperature within a component of system 20 (e.g., housing 64 or housing 38), or environmental temperature outside system 20. In some embodiments, temperature monitor 78 detects and/or measures temperature during an automatic mode 48, bleed mode 46, or shut-in mode 44. In some embodiments, temperature monitor 78 records data indicative of or related to temperature detected and/or measured. In some embodiments, temperature monitor 78 provides data (e.g., temperature data) to an alarm unit 80.

In some embodiments, alarm unit 80 receives data from one or more components of system 20. In some embodiments, alarm unit 80 stores, records, transmits data, and/or actuates a notification related to and/or based on the data received. For example, in some embodiments, alarm unit 80 can receive temperature data from temperature monitor 78 and update an error counter log (e.g., stored locally and/or on a remote system/computer), and/or actuate a notification (e.g., message, alarm, sound, alert, etc.) based on the temperature data. For example, the notification can convey a low temperature alarm if the temperature data received from the temperature monitor 78 indicates and/or is processed by alarm unit 80 to indicate that an ambient temperature in system 20 (e.g., where a data logger is situated) is below a threshold value. In some embodiments, alarm unit 80 can receive pressure data from a pressure monitor (e.g., surface casing pressure monitor 66, production tubing pressure monitor 70, production casing pressure monitor 72, and intermediate casing pressure monitor 68), update an error counter log, and/or actuate a notification based on the pressure data. For example, the notification can convey a high pressure alarm if the pressure data indicates (e.g., before or after processing) that a pressure at a particular location (e.g., at surface casing, production tubing, production casing, other component of system 20, etc.) is above a threshold value.

In some embodiments, alarm unit 80 can receive and be triggered by data indicating that the flow rate of gas exiting the well exceeds the maximum threshold of the flow meter or the maximum threshold at which the flow meter can accurately measure flow rate (e.g., 300 m³/day in some embodiments). In some embodiments, based on an alarm indicating that the flow rate of gas exiting the well exceeds the maximum threshold of the flow meter, a user of system 20 may elect not to accept or have regard to flow rate data measured after such an alarm point, and/or system 20 may direct the flow of gas through measurement exhaust 32. In some embodiments, alarm unit 80 can receive and be triggered by data indicating a low battery state, for example as the voltage drops below a predetermined value, an alarm condition can be generated to alert the user to consider replacing any batteries used to supply power to system 20 or installing new or additional solar panels to supply power to system 20.

In some embodiments, alarm unit 80 designates one or more datasets received with a status indicator, for example, denoting a critical alarm condition. In some embodiments, a critical alarm condition is activated or present (e.g., data received can be associated with a status indicator denoting a critical alarm condition based on the contents of the received data) the system 20 is set in a critical alarm state and the critical alarm condition is not removed until the critical alarm state is corrected. For example, alarm unit 80 can receive data from temperature monitor 78 that indicates an ambient temperature above or below a threshold value, store the ambient temperature data, associate the data with a critical alarm condition status indicator, and actuate a critical alarm state of system 20. Temperature monitor 78 can monitor the ambient temperature and transmit data indicating new temperature recordings to alarm unit 80. Alarm unit 80 can receive the new temperature recording data and, if this new temperature data is above or below a threshold value or difference from the previous temperature recording (e.g., the temperature recording data associated with the critical alarm condition), cancel the critical alarm condition associated with the recorded ambient temperature, and system 20 can exit the critical alarm state.

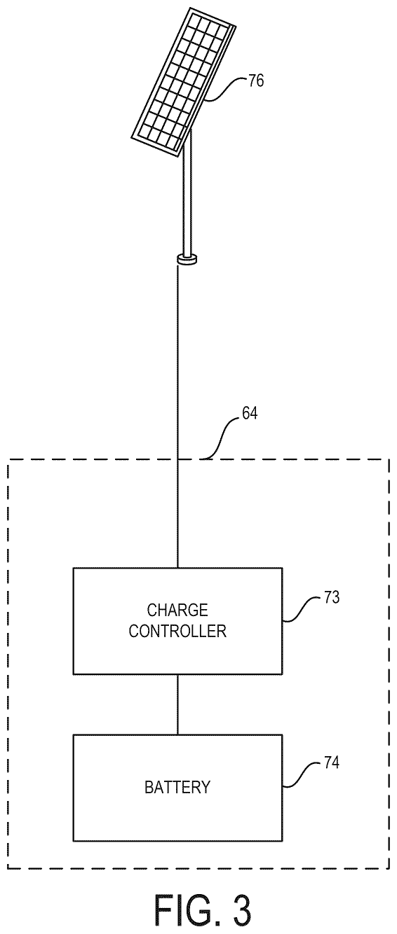

In some embodiments, a battery 74 is provided to power logging memory 40 and communications unit 50. In some embodiments, battery 74 is housed within housing 64. In some embodiments, battery 74 is housed external to housing 64. In some embodiments, a solar panel 76 is provided to charge battery 74. For example, FIG. 3 is a schematic diagram of an example power management system for a methane monitoring, logging and conversion system 20, according to some embodiments, having a solar panel 76 to supply power to battery 74 via a charge controller 73.

In some embodiments, the system 20 enters a low power mode or sleep state between measurements. In some embodiments, in the sleep state, the system cuts power to all instruments except the actuator used to actuate switching valve 30, flow meters 26, 28, and communications unit 50. When system 20 is taking measurements, the controller 68 powers the necessary sensors, takes updated measurements, sends the new readings to the communications unit 50 and saves a log of the updated values to the logging memory 40. In some embodiments, logging memory 40 is a local USB memory. After these steps have been completed, system 20 returns to the sleep state. In some embodiments, the wake period during which measurements are taken is approximately 15 seconds and the sleep cycle is approximately 45 seconds, so that the sleep interval or period covered by each sleep-wake cycle is approximately 1 minute.

In one example embodiment, when system 20 is in automatic mode 48, the system 20 will initially direct the flow of venting gases to high flow range flow meter 28. If it is determined that the flow rate of the vented gases is below a predetermined level, then the system 20 will actuate switching valve 30 to direct the flow of vented gases to low flow range meter 26. In some embodiments, the predetermined level below which the flow of vented gases is directed to low flow range meter 26 is less than about 6 m³/day, including any lower value, e.g., 5.5, 5.0, 4.5, 4.0, 3.5, 3.0, 2.5, 2.0, 1.5 or 1.0 m³/day.

In some embodiments, if bleed mode 46 is activated, the flow of vented gases will be directed directly to bleed off vent 25, bypassing flow meters 26, 28 and methane detector 34. In some embodiments, in the event of a loss of power, system 20 will use a back-up power source to direct flow directly to bleed off vent 25, bypassing flow meters 26, 28 and methane detector 34. In alternative embodiments, the flow of gas could be directed to measurement exhaust 32 to bypass flow meters 26, 28, methane detector 34 and methane converter 36.

In some embodiments, when shut-in mode 44 is activated, the surface casing vent line will be shut in to allow pressure to build up in the surface casing vent. In some embodiments, during operation in shut-in mode 44, system 20 continues to record such data as pressure measured by pressure monitors 66, 68, 70 and 72.

In some embodiments, a remote bleed function is provided. The remote bleed function works in the same way as bleed mode 46, but is activated remotely, e.g., using a web-based interface. The remote bleed function can be activated by a remote computer, for example. In some embodiments, the system must be operating in automatic mode 48 in order for the remote bleed function to be used.

In some embodiments, a high speed logging function is provided. The high speed logging function is used to identify a level of gas flow equivalent to the flow of bubbles breaking the water surface in a bubble test as is currently used to measure gas flow. For example, AER Directive 20 states that any well that has a gas flow rate that exhibits any bubble flow within a ten minute period cannot be cut-and-capped. Accordingly, in embodiments intended to replace the use of a conventional bubble test, system 20 must be able to measure very low gas flows even if such flow is sporadic, e.g., equivalent to the production of a bubble every seven minutes. A bubble popping event takes less than one second to occur, so to accurately characterize such wells, measurements must be made and recorded at least every second. For example, a digital laminar flow meter is able to take measurements on a millisecond timescale. In some embodiments, in high speed logging mode, a sample is taken every 5 to 10 milliseconds, including e.g., every 6, 7, 8 or 9 milliseconds.

In some example embodiments, the default logging duration is ten minutes. In some embodiments, measurements are logged once per minute.

In some embodiments, methane converter 36 is a thermal catalytic converter, for example as described in Canadian patent No. 2325966, which is incorporated by reference in its entirety herein. In some embodiments, a plurality of methane converter units are used to provide methane converter 36, e.g., two, three, four, five or more methane converter units, depending on the rate of methane being released. In some embodiments, the volume of methane converted to carbon dioxide by methane converter 36 is measured by methane detector 34, to allow a user of system 20 to apply for any relevant government credits or benefits relating to the amount of methane diverted from entering the atmosphere.

In alternative embodiments, methane converter 36 is any suitable type of converter, for example a catalytic converter, for example, a converter using an oxidation catalyst; a dual-bed catalytic converter; a three-way catalytic converter; a catalytic converter that uses an oxidation catalyst and a reduction catalyst; converter with a palladium or platinum face; and/or other catalytic converter.

In some embodiments, system 20 includes one or more methane converters 36.

The methane converters 36 can operate in sequence, for example, with an output of a first methane converter 36 provided as one or more input streams to one or more subsequent methane converters 36 and so on. In some embodiments, the sequence and/or identity of the one or more methane converters 36 can help minimize the amount of one or more gases (e.g., methane) released into the atmosphere from a gas-emitting system such as a wellbore.

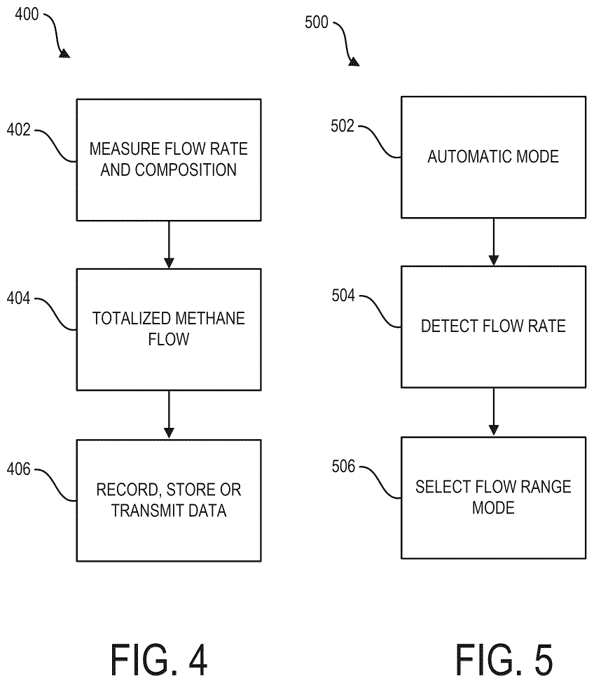

FIG. 4 is an example flow diagram illustrating an example process 400 for methane detection using system 20, according to some embodiments. At 402, system 20 is configured to measure vent gas flow rate from either of low flow rate flow meter 26 or high flow rate flow meter 28. The proportion of methane present in the vent gas is measured by methane detector 34. System 20 is configured to measure or generate a methane composition data value based on the vent gas flow rate. At 404, system 20 is configured to generate totalized methane flow data based on the vent gas flow rate and the methane composition data value obtained at 402. For example, the totalized methane flow data can be data representing an amount of methane flow from the well head per volume or per unit time of gas flow from the well head. At 406, system 20 is configured to record, store, and/or transmit data such as data derived from or indicating the totalized methane flow rate, vent gas flow rate, and/or methane composition. For example, system 20 at data storage unit 40 (e.g., data logging memory 40) is configured to store data, for example, as a log.

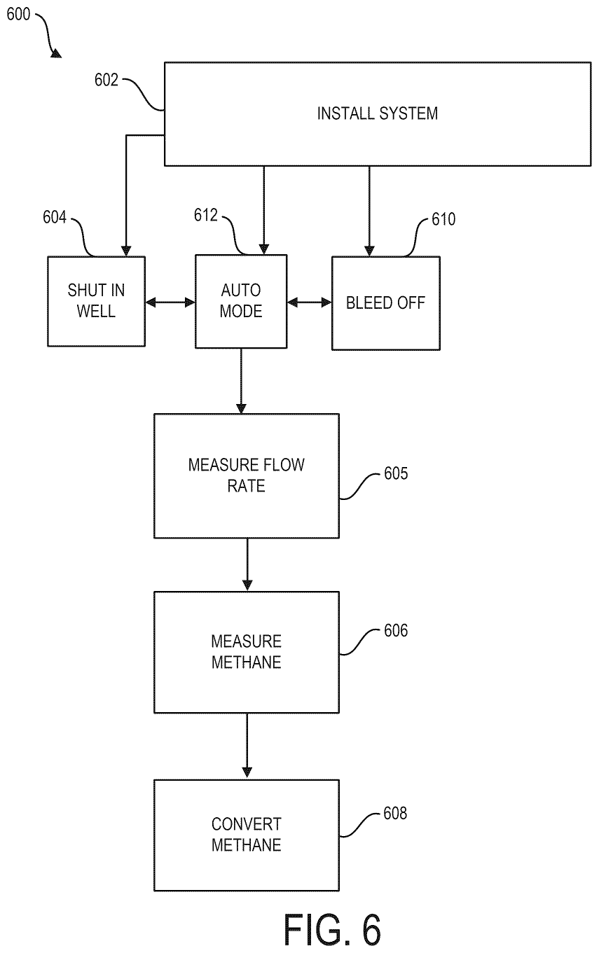

FIG. 5 is an example flow diagram of an example process 500 for methane detection using system 20 installed at a vent (e.g., at a well-head), according to some embodiments. In some embodiments, step 402 includes steps 502, 504, and 506.

At 502, system 20 enters automatic mode 48 where system 20 can initially enter a high flow rate detection mode. For example, in some embodiments, in the high flow rate detection mode, a switching valve 30 is configured so that vent gas is directed to high flow range flow meter 28.

At 504, system 20 is configured to detect a vent gas flow rate of gas from the vent using a sensor, e.g., a laminar flow meter. For example, the vent gas flow rate can be detected at one or more values or to be within a range of values.

At 506, system 20 is configured to select a flow rate range mode based on the detected vent gas flow rate. If system 20 (e.g., using laminar flow meter) detected a low flow rate, system 20 is configured to enter a mode that detects flow rates within a low flow rate range using low flow rate flow meter 26. For example, if system 20 (e.g., using high flow range flow meter 28) detected a low flow rate, switching valve 30 is configured to direct gas to low flow range flow meter 26. During operation or at step 504, if system 20 detects a high flow rate, system 20 is configured to enter a mode that detects flow rates within a high flow rate range. For example, if system 20 (e.g., using laminar flow meter) detected a high flow rate, switching valve 30 is configured to direct the flow of gas through a high flow range flow meter 28 so that gas is directed to high flow range flow meter 28 when the gas flow rate is high. In some embodiments, system 20 switches between a high flow rate detection mode and low flow rate detection mode one or more times, for example, based on changing or fluctuating flow rates of gas from the vent.

As gas flow rate is being measured by either of flow meters 26, 28, system 20 can then take one or more measurements using monitor(s) and/or sensor(s) and data storage unit 40 can record and/or store same.

In some embodiments, system 20 at alarm unit 80 is configured to trigger a notification (e.g., an alarm) based on a predetermined vent gas flow rate or other desired parameter. For example, if the vent gas flow rate is above a threshold value, alarm unit 80 is configured to trigger a notification indicating that a vent flow (e.g., surface casing vent flow) is serious. If the the gas flow rate is below a threshold value, alarm unit 80 can be configured to trigger a notification indicating that a vent flow (e.g., surface casing vent flow) is non-serious or within acceptable operating parameters for flow meters 26, 28, for example.

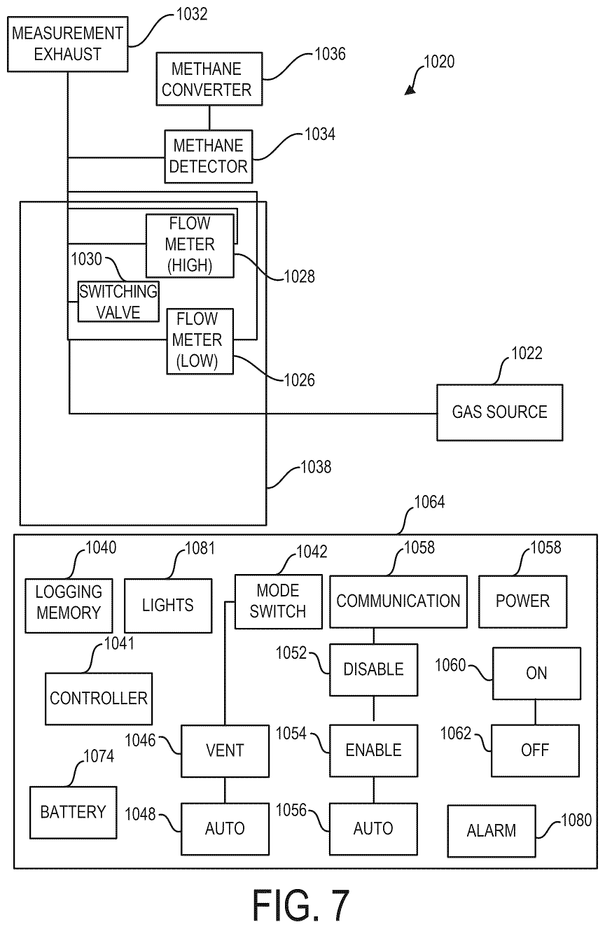

FIG. 6 is an example flow diagram of an example process 600 for operating system 20, according to some embodiments. As shown in FIG. 1, in some embodiments, system 20 is configured to operate in at least a shut-in mode 44, bleed off mode 46, and automatic mode 48.

At 602, system 20 is installed at a vent, e.g., a wellhead.

System 20 is configured to enter and/or exit a shut-in mode 44 at 604, bleed off mode 46 at 610, and automatic mode 48 at 612. For example, a user can engage with a mode switch control 42 to toggle system 20 between a shut-in mode 44, bleed off mode 46, and automatic mode 48. In some embodiments, system 20 is configured to allow for remote control when in the automatic mode 48. In some embodiments, system 20 is configured to enter a sleep mode, e.g., to conserve battery power. When the system is switched to a different mode from sleep mode, system 20 may take a period of time, such as one to two sleep cycles (e.g., 1-2 minutes) for the switch position to be acknowledged by the controller. When the system is in sleep mode, system 20 may wake up only to record measurements and then return to sleep, for example taking and recording a measurement every 1-2 minutes, to minimize the amount of power consumed by system 20.

At 604, system 20 is configured to enter a shut-in mode 44 and shut-in the well.

When system 20 is in shut-in mode 44, in some embodiments, data storage unit 40 is configured to record measurements taken from surface casing pressure monitor 66, intermediate casing pressure monitor 68, production casing pressure monitor 72, and temperature monitor 78 (e.g., that can measure temperature within enclosure 38).

At 610, e.g., as may occur upon loss of power or system failure, system 20 is configured to direct the flow of gas to a bleed off vent 25 to exit system 20, bypassing flow meters 26, 28 and methane detector 34 and/or methane converter 36. Further, in some embodiments, data storage unit 40 is configured to record timestamp data (e.g., denoting a time that one or more measurements are taken or that the mode in which system 20 is operating is changed). In alternative embodiments, rather than directing the flow of gas to bleed off vent 25, gas could be directed to measurement exhaust 32 to bypass flow meters 26, 28, methane detector 34 and methane converter 36.

At 612, system 20 is configured to enter an automatic mode 48. In automatic mode 48, system 20, for example, at data storage unit 40, is configured to log a measurement or set of measurements. Such logging can be performed once per minute, for example. In some embodiments, system 20 can enter a high speed logging function. When system 20 is in automatic mode 48, in some embodiments, data storage unit 40 is configured to record measurements taken from surface casing pressure monitor 66, intermediate casing pressure monitor 68, production casing pressure monitor 72, temperature monitor 78 (e.g., that can measure temperature within enclosure 38), flow meter (high) 28, and/or flow meter (low) 26. Further, in some embodiments, data storage unit 40 is configured to record timestamp data (e.g., denoting a time that one or more measurements are taken).

In some embodiments, system 20 is configured to enter into a high speed logging function. In a high speed logging function, system 20 is configured to take measurements at one or more monitors or sensors at a higher frequency. The frequency can be approximately seven readings per second, for example, or more, with measurements being made and recorded on a millisecond timescale. For example, the measurements can be taken using flow meter (high) 28 and/or flow meter (low) 26, and timestamp data can also be recorded. In some embodiments, system 20 does not enter sleep mode when it is in high speed logging mode.

At 606, in automatic mode 48, system 20, using methane detector 34, is configured to monitor, detect, and/or measure one or more properties of component(s) from the vent, for example, gas flow rate at 605 and/or methane composition/amount at 606.

At 608, after methane composition and flow rate of the vent gas have been measured, system 20, using methane converter 36, is configured to catalytically convert methane present in gas being exhausted from a vent to a different compound, to reduce the level of greenhouse gas emissions, for example, from wellhead 22. For example, methane detector 34 can be used to measure or quantify a percentage of methane contained in a gas flow from a vent, and methane converter 36 can convert one or more components of that gas flow (e.g., methane) to one or more other compounds, for example carbon dioxide.

In some embodiments, methane converter 34 catalytically converts methane to a different compound without system 20 using methane detector 34 to detect methane. In some embodiments, methane converter 36 catalytically converts methane to a different compound following detection or measurement of methane amount or composition by methane detector 34.

At 610, in bleed-off mode 46, system 20 passes gas through bleed off vent 25. For example, if a pressure monitor (e.g., 66, 68, 70, or 72) detects or measures a pressure above a threshold value, in some embodiments, system 20 is configured to enter bleed-off mode at 610 by directing the flow of gas through bleed off vent 25. In some embodiments, alarm 80 is triggered if bleed-off mode is entered.

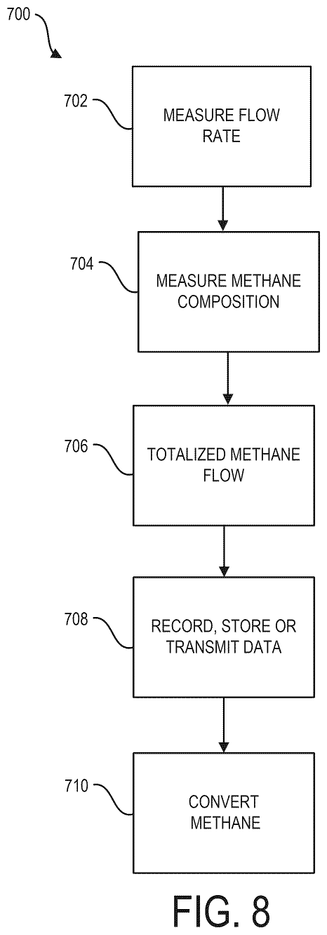

FIG. 7 is an example embodiment of a system 1020 that is similar to system 20 and is operated in a similar manner, but which can be installed at a source of methane other than a wellhead. Components of system 1020 that are similar to components of system 20 are illustrated with reference numerals incremented by 1000, and are not further described herein. System 1020 is generally similar to system 20, except that components that are specific to the operation of the system at a wellhead (e.g., shut in 24, bleed off vent 25, pressure monitors 66, 68, 70, 72, and the like) are omitted.

System 1020 is installed at a gas source 1022 from which it is desired to monitor and/or convert methane emissions. Gas flows from gas source 1022 to system 20. In automatic mode 1048, gas flow is directed initially to high flow range flow meter 1028 and either gas flow rate is measured or, if high flow range flow meter 1028 determines that the flow rate from gas source 1022 is low, switching valve 1030 directs the flow of gas to low flow range flow meter 1026, which measures gas flow rate. At any time, if low flow range flow meter 1026 determines that gas flow rate is too high, switching valve 1030 directs the flow of gas to high flow range flow meter 1028.

Gas is also directed through a methane detector 1034, so that the proportion of methane in the gas flow can be determined. The data obtained from flow meters 1026, 1028 and methane detector 1034 can be used to determine the totalized flow of methane emitted by gas source 1022 in the same manner as described for system 20. Although methane detector 1034 has been illustrated as being positioned downstream of flow meters 1026, 1028, in alternative embodiments methane detector 1034 could be positioned upstream of flow meters 1026, 1028, or flow meters 1026, 1028 could be positioned downstream of methane converter 1036. It is important that methane detector 1034 be positioned upstream of methane converter 1036 where used, as the proportion of methane present in emissions from gas source 1022 could not be determined after the methane has been converted to another compound by methane converter 1036.

In some embodiments, after passing through methane detector 1034, gas is then directed to a methane converter 1036, so that the methane can be converted to a different compound, for example carbon dioxide. Any type of methane converter described for methane converter 36 can be used for methane converter 1036.

In vent mode 1046, the flow of gas from gas source 1022 can be directed so as to bypass all of flow meters 1026, 1028, methane detector 1034, and methane converter 1036 and exit from system 1020 via measurement exhaust 1032.

In some embodiments, system 1020 is installed at a vent for a methane source 1022. In some embodiments, the methane source 1022 is an ethylene glycol purifier, glycol dehydrator tower, compressor seal, pneumatic control, or solution gas tank. In some embodiments, the flow meters used in system 1020 are selected to be accurate at flow rate ranges that are relevant to the anticipated flow rate for the methane source with which system 1020 is to be used. For example, solution gas tanks may vent more than 300 m³/day and therefore larger capacity flow rate meters than described with reference to system 20 would be used; surface casing vent flow values are typically in an ultra low flow rate range whereas solution gas tanks and other potential sources of methane may have higher flow rates.

For example, in some embodiments, methane source 1022 is a glycol dehydrator tower. In some embodiments, system 1020 is installed at a glycol dehydrator tower, for example, at a vent from same that emits a gas that may or does contain methane. In some embodiments, system 1020 is configured to detect and/or measure methane at methane detector 1034 and convert methane to another component at methane converter 1036 to monitor and/or minimize methane emissions from the glycol dehydrator tower.

As another example, in some embodiments, methane source 1022 is a compressor seal. In some embodiments, system 1020 is installed at compressor seal, for example, at a vent from same that may or does contain methane. In some embodiments, system 1020 is configured to detect and/or measure methane at methane detector 1034 and convert methane to another component at methane converter 1036 to monitor and/or minimize methane emissions from the compressor seal.

As another example, in some embodiments, methane source 1022 is a pneumatic control. In some embodiments, system 1020 is installed at a pneumatic control, for example, at a vent from same. In some embodiments, system 1020 is configured to detect and/or measure methane at methane detector 1034 and convert methane to another component at methane converter 1036 to monitor and/or minimize methane emissions from the pneumatic control.

As another example, in some embodiments, methane source 1022 is a surface casing vent at a wellhead, and system 1020 is used to monitor and/or minimize methane emissions from the wellhead in a manner similar to system 20 without being used to regulate any functions of the well such as shut-in or venting. In some embodiments, system 1020 is configured to detect and/or measure methane at methane detector 1034 and convert methane to another component at methane converter 1036.

As another example, in some embodiments, methane source 1022 is a solution gas tank. In some embodiments, system 1020 is installed at solution gas tank, for example at a vent associated with same. In some embodiments, system 1020 is configured to detect and/or measure methane at methane detector 1034 and convert methane to another component at methane converter 1036.

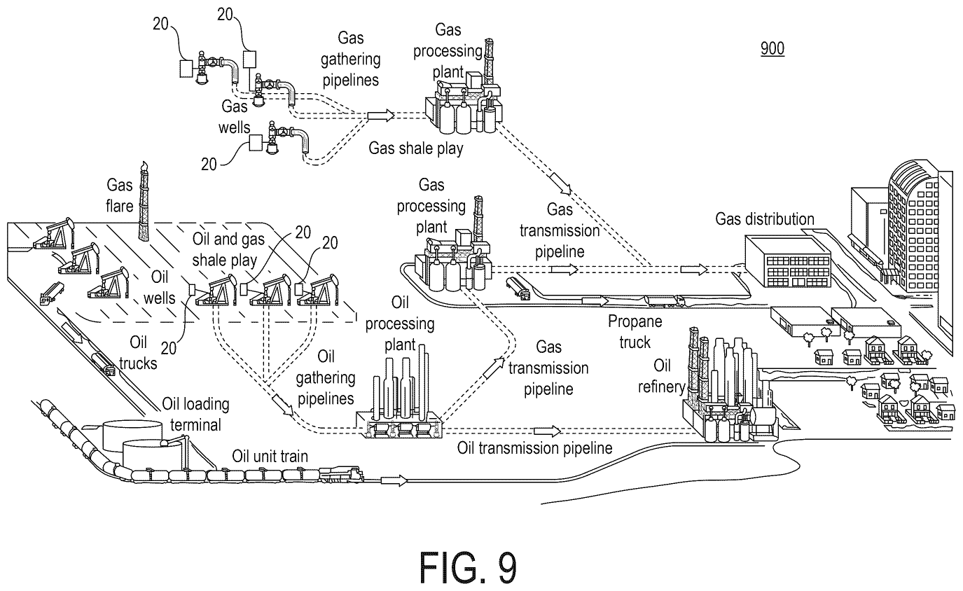

FIG. 8 shows an example embodiment of a method 700 of using system 1020 to monitor and convert methane emissions from gas source 1022. At 702, the flow rate of gas emitted by gas source 1022 is determined, e.g., using flow meters 1026 and/or 1028.

At 704, the methane composition of gas emitted by gas source 1022 is determined, e.g., the percentage or proportion of the emitted gas that is methane is determined using methane detector 1034.

At 706, a totalized methane flow is determined, for example per unit volume of gas released by gas source 1022 or per unit time, or a total volume released within a given study period.

At 708, data pertaining to the flow rate, methane composition, and any other desired parameters measured by system 1020 is recorded, stored and/or transmitted, for example via logging memory 1040 and/or communications module 1058.

At 710, methane in the gas flow is converted to a different compound, for example carbon dioxide, using one or more methane converters 1036.

In some embodiments, system 20 or 1020 does not include a methane converter 36 or 1036 where the methane source 22 or 1022 is below a threshold size, emits gas below a threshold gas flow, or emits methane below a threshold methane amount or percentage in a gas flow. In some embodiments, system 20 or 1020 includes a methane converter 36 or 1036, for example, where methane source 22 or 1022 is above a threshold size, emits gas above a threshold gas flow, or emits methane above a threshold methane amount or percentage in a gas flow. In some embodiments, system 20 or 1020 includes a second methane detector positioned downstream of methane converter 36 or 1036, in order to evaluate what percentage of methane is converted to a different compound by methane converter 36 or 1036. As government regulations and pricing around the release of methane increase, it is anticipated that the threshold level of methane at which a methane converter is included as a component of the system will decrease.

In some embodiments, system 20 or 1020 is configured to output data confirming the amount of methane released from gas source 22 or 1022 over a given period of time, and the amount of methane that was diverted from being released to the atmosphere by reason of the use of methane converter 36 or 1036 to convert the methane to a different compound, for example carbon dioxide. Such information may be used by the operator of system 20 or 1020 for purposes such as internal monitoring, external reporting (e.g., to governments or regulatory agencies), claiming emissions credits, monitoring compliance with emissions regulations, or any other desired purpose.

Further disclosed herein are several additional aspects of the present disclosure that may be implemented in addition, or in alternative, to those discussed above. These additional aspects relate to devices, systems, and methods that can be together (in any combination) or separately incorporated into any of those discussed elsewhere herein. As further explained below, at least three of these several additional aspects of the present disclosure can be used in an example of calculating mass flow from volumetric flow and the ability to convert that to Global Warming Potential (GWP). GWP is a measure used to evaluate the potency of different greenhouse gases in trapping heat in the Earth's atmosphere over a specific period, usually 100 years, compared to carbon dioxide (CO2). It allows for the comparison of the warming effects of various greenhouse gases based on their ability to absorb heat and their atmospheric lifetimes. The GWP values enable policymakers, scientists, and environmentalists to assess the relative contributions of different greenhouse gases to global warming and prioritize efforts to mitigate climate change. It helps in formulating strategies to reduce emissions of gases with high GWPs and transition to cleaner energy sources and practices.

A first general additional aspect includes a database knowledge of source and/or sink geolocations. Known dataloggers allow, sometimes exclusively, users to self-input their geolocation. This in turn allows end users to deceive certain systems (e.g., regulators and/or regulative bodies) by “double counting” emissions sources. In contrast, the database knowledge of the present disclosure is distinguished from others in that the geolocations (e.g., global positioning system coordinates, IP addresses, etc.) therein can be automatically determined. Implementations of the present disclosure using this feature help to create a database of geolocations of known emissions. This determination of geolocations can be a feature of connected software to devices and systems for example.

In addition, or in alternative, the several additional aspects of the present disclosure can include Application Programming Interface (API) connectivity to validate the quantification. Traditional methods of data validation often involve manual checks or reliance on local validation routines, which may be limited in scope or effectiveness. There is a need for an automated and scalable solution that can efficiently validate data against predefined rules or criteria. The proposed device, system, and method provide a robust solution for data validation using API connectivity. For instance, the system facilitates the verification of data integrity and accuracy through interaction with external services via API endpoints. By leveraging external services through API endpoints, the system enables efficient, scalable, and accurate validation of data in diverse applications and systems. This aspect can be combined with the source and sink data in the database knowledge to enable additional features.

In addition, or in alternative, the several additional aspects of the present disclosure can include references to barometric pressure rather than a static pressure for calibration. This aspect can be performed by a sensor assembly that is integrated into the devices and systems disclosed herein. While standard pressure serves as a standardized reference value for comparison and calculation purposes, particularly in scientific and engineering contexts, barometric pressure represents the actual atmospheric pressure at a specific location and time. In this respect, devices and systems disclosed herein can be portable but do not need to be recalibrated if they are relocated. What is more, these values can be used in certain equations to arrive at values that are useful for those devices and systems. Incorporating use of the barometric pressure can be combined with the first two several additional aspects of the present disclosure.

As backdrop for the above several additional aspects, discussion now turns to environments in which the principles of the present disclosure can be deployed. Emissions represent the release of greenhouse gases into the atmosphere from various human and natural activities. A source refers to any process or activity, whether natural or human-induced, that releases greenhouse gases (GHGs) or aerosols into the atmosphere. Conversely, a sink is a mechanism, process, or activity that removes a GHG, aerosol, or precursor of a GHG or aerosol (such as volatile organic compounds and nitrogen oxides) from the atmosphere. Major GHGs such as carbon dioxide, methane, and nitrous oxide are primary examples of sources and sinks.

Carbon dioxide (CO2) has natural sources such as microbial decomposition of organic material in the presence of oxygen, forest fires, and volcanoes. Human-induced sources include the burning of fossil fuels, deforestation, and the burning of solid waste. CO2 sinks include photosynthetic vegetation, reforestation, and soils.

Methane (CH4) has natural sources such as microbial decomposition of organic material in the absence of oxygen (such as wetlands, permafrost, oceans, and freshwater bodies), termites, and wildfires. Human-induced sources include livestock via enteric fermentation, manure management, rice cultivation, waste management (such as landfills and burning biomass), and energy production from natural gas, coal, and petroleum. CH4 sinks include upland soils containing methane-oxidizing bacteria (methanotrophs) and oxidation within the troposphere by hydroxyl radicals.

Nitrous oxide (N2O) has natural sources primarily from soils and the ocean via denitrification. Human-induced sources include production and use of nitrogen fertilizers, combustion of fossil fuels, burning of biomass, and manure management. N2O sinks include destruction in the stratosphere via photolysis.

A relationship exists between emissions and biogas in that there is potential for biogas production to mitigate greenhouse gas emissions. Biogas, primarily composed of methane and carbon dioxide, is generated through the anaerobic digestion of organic materials such as agricultural waste, sewage, and food scraps. By capturing methane emissions from decomposing organic matter and converting them into biogas, the process not only produces a renewable energy source but also prevents methane, a potent greenhouse gas, from being released into the atmosphere. Biogas can be utilized in multiple sectors, including electricity generation, heating, and transportation fuel. In electricity generation, biogas can be used to fuel generators or turbines to produce electricity, offering a reliable and sustainable power source. Additionally, biogas can be purified and injected into natural gas pipelines or compressed for use as vehicle fuel, providing an eco-friendly alternative to conventional fossil fuels. Moreover, biogas can be utilized for heating purposes in residential, commercial, or industrial settings, offering a renewable and efficient heat source. Overall, the diverse applications of biogas demonstrate its potential to contribute significantly to renewable energy goals while mitigating greenhouse gas emissions and promoting sustainable development. Thus, biogas production serves as a dual-purpose solution by both reducing emissions and providing a sustainable energy alternative.

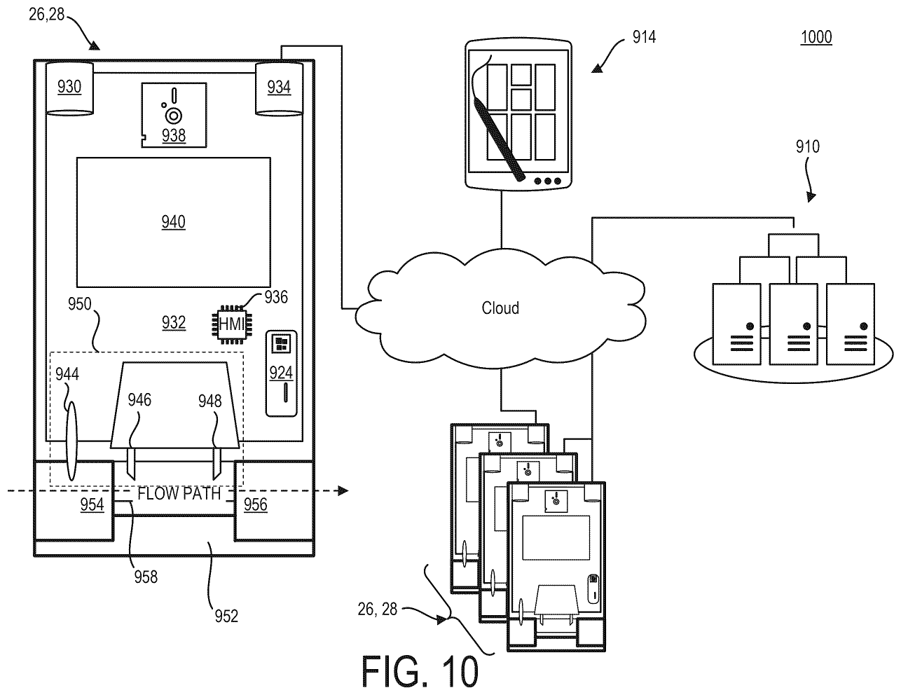

FIG. 9 depicts an intricate network 900 of transportation modes that collaborate in the transportation of oil and gas from production sites to end-users. These modes include pipelines, rail, highways, and waterways, which interconnect the oil and gas production infrastructure (comprising wells and processing plants) in shale regions with refineries, industrial consumers, and individual customers. Moreover, in cases where products need to switch transportation modes, oil-loading terminals, also known as transload terminals, facilitate the transfer of the product from one mode to another. For instance, crude oil may be transferred from a truck or gathering pipeline to a train at these terminals. The responsibility for maintaining these transportation modes varies, with pipelines and rail being predominantly privately owned, while highways and waterways are generally public. Emissions in the oil and gas industry, including carbon dioxide, methane, and other pollutants, contribute significantly to global greenhouse gas emissions, impacting climate change and air quality.

In this light, one or more of system 20 are placed throughout this network 900 as shown. As noted above, this system 20 is an emission measuring, logging and conversion system for use at sources such as a wellhead or along portion of pipelines. System 20 is used to monitor, record and catalytically convert methane being released from these sources. These are just some example placements and functions of the many disclosed herein and that will be apparent to those skilled in the art.

The oil and gas industry encompasses a global network 900 of processes, including exploration, extraction, refinement, transportation (often via oil tankers and pipelines), and marketing of petroleum products. The industry's primary products are fuel oil and gasoline (petrol), with petroleum also serving as the raw material for many chemical products, including pharmaceuticals, solvents, fertilizers, pesticides, and plastics. The upstream oil sector, also known as the exploration and production (E&P) sector, involves the search for potential underground or underwater crude oil and natural gas fields, drilling of exploratory wells, and operating wells that recover and bring crude oil (which may contain gas/gas liquids) and/or raw natural gas (which may contain gas liquids) to the surface. Recently, unconventional gas has also been included in the upstream sector. The downstream sector refers to the refining of petroleum crude oil, the processing and purifying of raw natural gas, and the marketing and distribution of products derived from crude oil and natural gas. This sector touches consumers through products such as gasoline, kerosene, jet fuel, diesel oil, heating oil, fuel oils, lubricants, waxes, asphalt, natural gas, and hundreds of petrochemicals.

The relationship between oil and gas is symbiotic, as both resources are often found together in underground reservoirs and are commonly extracted and processed together for various energy and industrial purposes. An oil refinery or petroleum refinery is an industrial process plant where crude oil is processed and refined into more useful products, including petroleum naphtha, gasoline, diesel fuel, asphalt base, heating oil, kerosene, and liquefied petroleum gas. These refineries (or processing plants) are typically large, sprawling industrial complexes with extensive piping carrying streams of fluids between large chemical processing units.

Abandoned oil and gas wells represent a significant source of uncertainty when it comes to methane emissions into the atmosphere. In fact, they are considered the most uncertain methane source in both the United States and Canada. Understanding the extent of methane emissions from these wells is crucial in gaining insights into the broader environmental impacts of abandoned wells, which are rapidly increasing in number worldwide to meet the ever-growing demand for energy. The term “abandoned wells” encompasses various types of wells, including those with no recent production and no plugging, those that are temporarily inactive or shut-in, and those that have been orphaned or deserted. Additionally, emissions from wells that have been plugged to prevent gas or fluid migration were not previously included in prominent studies. Such emissions can be characterized by their mass flows.

In principal, there are two types of flow in a pipe. With Re<2000 the viscous forces dominate in the medium and the flow becomes laminar. This means that different layers of the medium move in relation to each other in the proper order. The velocity distribution across the laminar layers is usually parabolic shaped. With Re≥4000 the inertia forces dominate the behavior of the flowing medium and the flow becomes turbulent, with particles moving randomly across the flow. The velocity distribution across a layer with turbulent flow becomes diffuse. In the critical area, between Re≤2000 and Re≥4000, the flow conditions are undetermined, either laminar, turbulent or a mixture of the both. The conditions are governed by factors such as the surface smoothness of the pipe or the presence of other disturbances. To start a flow in a pipe, a specific pressure difference to overcome the friction in the pipe and the couplings is required. The amount of pressure difference depends on the diameter of the pipe, its length and form as well as the surface smoothness and Reynolds number.

The measurement of mass flow can be accomplished through the use of mass flow instruments, which rely on the principle of differential pressure-based laminar flow measurement. Flow devices and controllers disclosed herein are advanced multiparameter instruments that not only provide data on pressure and temperature, but also allow for the determination of both volumetric and mass flow rates. In the case of internally compensated laminar (ICL) units, one approach to flow measurement is based on the Poiseuille Equation, which involves the creation of an internal restriction known as a Laminar Flow Element (LFE). The LFE facilitates the movement of gas molecules in parallel paths along the length of the passage, thereby minimizing flow turbulence. The differential pressure drop within the laminar region is then measured.

The Poiseuille Equation relates pressure drop to laminar flow rate as follows: Q=(P₁−P₂)πr⁴/8ηL, where Q=Volumetric flow rate, P₁=Static pressure at the inlet, P₂=Static pressure at the outlet, r=Hydraulic radius of the restriction, η=Absolute viscosity of the fluid, and L=Length of the restriction. Since π, r and L are constant for a given LFE, the equation can be rewritten as: Q=K(ΔP)/η. In this equation, K is a constant factor determined by the geometry of the restriction. It shows the linear relationship between volumetric flow rate (Q), differential pressure (ΔP) and absolute viscosity (η) in a simpler form.

Changes in gas temperature affect the absolute viscosity of the gas. This requires a temperature measurement to determine the value of η. For most differential pressure-based devices, this is done by manually referencing charts that indicate the viscosity properties of the gas at given temperatures. In flow devices and controllers disclosed herein, this reference can be performed continuously using a discrete temperature sensor and a microprocessor.

At present, volumetric flow rate is ascertainable. However, in order to overcome the range limitations of thermal flow instruments, further measurements are required to accurately determine the mass flow rate of the gas in a laminar flow device. This can be achieved by considering the density correction factor and applying the formula: Mass=Volume*Density Correction Factor, which establishes the relationship between volumetric and mass flow.

Performing the mass flow calculations requires reference to a set of standard temperature and pressure conditions (STP) as indicated by the variables Tₛ and Pₛ. Standard flow rate is the equivalent flow rate the gas would be moving if the temperature and pressure were at standard conditions. It is usually the most useful measure of gas flow because it defines the mass flow, number of molecules, and heat-carrying capacity of the gas. STP is usually defined at sea level conditions, but no single standard exists for this convention. Examples of common STP reference conditions include: 0° C. and 1013 mbar, 25° C. and 14.696 psia, 0° C. and 760 torr or mmHg. Other manufacturers may use different values. Volumetric flow rate is the actual volume flow of the gas exiting the flowmeter.

The term “flow conditions” pertains to parameters such as temperature and static pressure of the substance being metered. These conditions are essential in determining the fluid density during flow. The resulting density is then used to adjust the measured volume to the base conditions. For gases, the density is computed using the ideal gas law and an equation of state calculation. Gas flow calculations are slightly more complex than for liquids because gases are compressible fluids whose density changes with pressure. In addition, there are two conditions that must be considered: low pressure drop flow and high pressure drop flow. It is noteworthy that the density of a gas is influenced by its temperature and absolute pressure, as revealed by the ideal gas laws as discussed below.

By applying the principles of ideal gas laws, one can observe the impact of temperature on density, while maintaining a constant pressure such that ρₐ/ρₛ=Tₛ/Tₐ where ρₐ=Density at flow conditions, Tₐ=Absolute temperature (° K) at flow conditions in Kelvin, ρₛ=Density at standard conditions (STP), Tₛ=Absolute temperature (° K) at standard conditions (STP) in Kelvin (° K=° C.+273.15). Similarly, the effect of absolute pressure on density (at constant temperature) is ρₐ/ρₛ=Pₐ/Pₛ, where ρₐ=Density at flow conditions, Pₐ=Absolute pressure at flow conditions, ρₛ=Density at standard conditions (STP), Pₛ=Absolute pressure at standard conditions (STP). To calculate mass flow rate (M), correct for temperature and absolute pressure's effects on density by applying two correction factors to volumetric flow rate (Q). The conversion can be expressed as: M=Q(Tₛ/Tₐ)(Pₐ/Pₛ).

In the disclosed flow device (or flow meter), a discrete absolute pressure sensor is placed in the laminar flow region. Data from this sensor, along with that from a discrete absolute temperature sensor, is used by the microprocessor to calculate mass flow. Mass flow is commonly expressed as a standardized volumetric flow rate, such as slm/slpm, sccm, or scfh. By knowing the device's STP setting and the density of a gas at that STP, the flow rate can be determined in grams per minute, kilograms per hour, and the like.

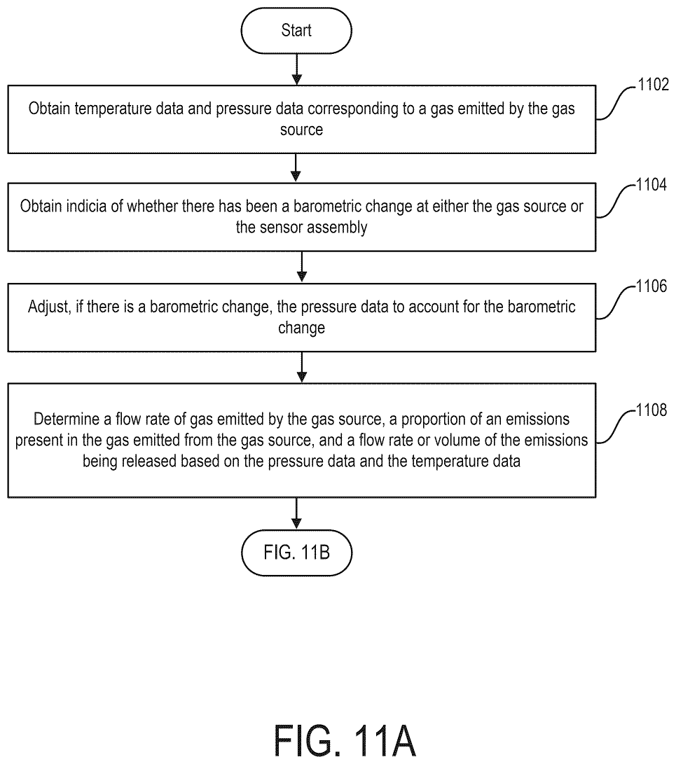

FIG. 10 shows a diagram of a network according to principles of the present disclosure. Some implementations herein relate to a system 1000 that includes one or more flow devices 26, 28 that are optionally in communication and/or working in concert with other flow devices 26, 28. As illustrated, some components of the system 1000 are remote from the flow device 26, 28 though that may not be the case in every implementation. Each of these flow devices 26, 28 can be in communication with a server 910 (e.g., via a cloud as shown). In this regard, the system 1000 can accomplish a variety of tasks. For example, system 1000 may be a system for compiling a database of geolocations of sources and sinks. In addition, or in alternative, the system 1000 may be a system for calculating carbon credits. Among other things, data, validation, and/or control features of any of the flow devices 26, 28 can be accessed via a remote device 914 (such as a phone, tablet, computer, or the like). In examples, this access is made possible via an API. Other embodiments of this aspect include corresponding computer systems, apparatus, and computer programs recorded on one or more computer storage devices, each configured to perform the actions of the methods. Each of the components discussed hereinafter can be similar to their equivalents or the like discussed elsewhere herein.

In general, flow device 26, 28 is used to measure the rate of fluid flow in a pipeline or system, providing real-time data related to fluid passing through it using various components. Flow device 26, 28 includes a power jack 930 receives input that electrifies the flow device 26, 28, which distributes electricity to other components via circuitry 932. Flow device 26, 28 communicates with other devices in the network via a communications unit 934, which can be a physical port or a device that functions as a receiver, transmitter, or transceiver. An interface 940 allows users to interact with the flow device 26, 28 and can be, for example, an analog or digital interface or display. Computing at the flow device 26, 28 is carried out via a processor 942 that executes instructions, a memory 936 that provides temporary storage for data and instructions needed by the processor 942, and a storage 938 that retains data and applications for long-term use. The efficiency and interaction between these components are essential for the overall performance and responsiveness of computing. The flow device 26, 28 includes a flow body 952 that defines a flow path, along which fluid or gas enters through a flow path inlet 954 and exits through a flow path outlet 956. An LFE 958 is disposed between the flow path inlet 954 and the flow path outlet 956.

A sensor assembly 950 of the flow device 26, 28 provides inputs for computing purposes. The sensor assembly 950 is a sensor or collection of sensors integrated into a single unit, designed to detect and measure various physical phenomena such as temperature, pressure, motion, or light in connection with computing. In this regard, the sensor assembly 950 includes a temperature sensor 944, an absolute pressure sensor 946, and a differential pressure sensor 948. Various pressure sensor ports can be present along the flow path to collect pressure readings along the flow path (e.g., at the flow path inlet 954 and the flow path outlet 956).

The server 910 is a computer system or a software program that provides services or resources to other computers, known as clients, over a network. In examples, the server 910 is a physical machine or a virtual instance running on a larger physical server 910. server 910 is designed to handle specific tasks or provide specific services, such as hosting websites, managing databases, handling email communications, or providing file storage. In this regard, there are implementations of the present disclosure that assign computational inferences to the flow device 26, 28, to the server 910, or split between the device and the server 910.

The server 910 can employ single and/or multitenant programs or algorithms in carrying out its tasks. A multitenant algorithm refers to an algorithm designed to efficiently manage resources or tasks for multiple users or tenants simultaneously. In computing, multitenancy refers to a software architecture where a single instance of the software serves multiple clients, known as tenants. Each tenant may have its own data, configuration settings, and user interfaces, but they all share the same underlying software infrastructure. A multitenant algorithm needs to handle the allocation and scheduling of resources or tasks in a way that ensures fair and efficient usage among the different tenants. It should also provide isolation between tenants to prevent interference or unauthorized access to each other's data. These algorithms often involve techniques such as resource partitioning, prioritization, and access control to achieve these goals. For example, in a cloud computing environment where multiple users share the same physical hardware, a multitenant algorithm might allocate CPU, memory, and storage resources dynamically based on the needs and priorities of each tenant. It could also implement quotas or rate limiting to prevent any single tenant from monopolizing resources and impacting the performance of others.

The described implementations may also include one or more of the following features. system 1000 can include a storage 938 to store as operational data that is measured by the flow device 26, 28 at least one of temperature data, pressure data, volume, and flow rates. The system 1000 can be configured to facilitate remote access to the operational data via an API. In examples, the system 1000 includes an API that enables connectivity to validate the quantification. system 1000 can include a flow device 26, 28 that is configured to quantify the emissions concentrations emitted from a gas source via the flow path while accounting for barometric changes at the flow device 26, 28. system 1000 can be configured such that the quantification occurs in about 140 milliseconds to capture low-end bubble flow. Implementations of the described techniques may include hardware, a method or process, or a computer tangible medium.

The described implementations of the flow device 26, 28 may include one or more of the following features. Flow device 26, 28 can have one or more processors that are configured to calculate a volumetric flow rate from a Poiseuille equation using a corrected pressure drop. Under these circumstances, the mass flow rate can be calculated using the temperature, the volumetric flow rate, and the absolute pressure. For example, flow device 26, 28 may include a flow path through which gas transmitted from the source or the sink flows. The flow path includes a flow path inlet 954 and a flow path outlet 956. Pressure sensors of the flow device 26, 28 can be positioned adjacent to the flow path inlet 954 and outlet to calculate a pressure drop across the flow path. These sensors can be integrated into a sensor assembly 950. The sensor assembly 950 may be configured to measure or otherwise determine at least one of a temperature at the flow device 26, 28, a pressure drop between the flow path inlet 954 and the flow path outlet 956, an absolute pressure at the flow device 26, 28, and a barometric pressure. This operational data can then be used to calculate flow rates, for instance the volumetric flow rate to then calculate the mass flow rate.

Flow device 26, 28 may include one or more processors in communication with the sensor assembly 950. One or more processors can be configured to adjust the pressure drop to generate a corrected pressure drop based on the barometric pressure if there has been a barometric change. If there has not been a barometric change, the one or more processors can use a previous pressure drop measurement, such as an immediately preceding value that was used. The one or more processors configured to calculate a mass flow rate of the gas flow using the temperature, the corrected pressure drop, and the absolute pressure. In examples, these calculations can aide in quantifying an amount of the emissions concentrations in the gas flow as a proportion of the gas flow using the mass flow rate. Other embodiments of this aspect include corresponding computer systems, apparatus, and computer programs recorded on one or more computer storage devices, each configured to perform the actions of the methods.

Because the system 1000 can determine barometric changes, the device can be self-calibrating. In other words, the device can self-calibrate based on an automatic reading of the geolocation and use accurate pressure readings for the geolocation. In contrast, traditional flow devices are calibrated to a single location and do not account for barometric changes. As used herein, self-calibrate refers to technology where a system or device's ability to automatically adjust and correct itself without the need for external intervention. It is commonly used in electronic devices, such as cameras, sensors, and measuring instruments, to ensure accurate and consistent performance over time. The self-calibration process typically involves the device comparing its readings or output to a known reference value or standard, and then making the necessary adjustments to correct any discrepancies. This can be achieved through the use of built-in algorithms or software that continuously monitor and analyze the device's performance and make real-time adjustments as needed. Self-calibration technology helps to improve the reliability and accuracy of devices, while reducing the need for manual calibration and maintenance. This feature of the flow device 26, 28 aids in portability of the device to discrete locations and simplifies manufacturing.

One or more processors is further configured to facilitate remote access to the flow device 26, 28. For instance, flow device 26, 28 may include a storage 938 for storing as operational data determined by the flow device 26, 28 at least one of temperature data, pressure data, volume, the mass flow rate, and the volumetric flow rate. Under these circumstances, the one or more processors is further configured to facilitate remote access to the operational data via an Application Programming Interface (API). In examples, there is a flow device 26, 28 where the API enables connectivity to validate the quantification and to calculate carbon credits based on the quantification.

In examples, there is a flow device 26, 28 where the sensor assembly 950 includes a gas chromatography detector arranged along the flow path. This detector can be positioned upstream or downstream of the flow device 26, 28. This feature is particularly helpful in that the detector can determine proportions of different emissions present within the flowing gas is transmitted from the sink or source. In examples, this feature can eliminate the need for separate gas-specific sensors, making for a more robust and simpler installation. Such a chromatography detector may conform to certain standards such as the Performance Specification 9 for Gas Chromatographic Continuous Emission Monitoring System. This specification establishes criteria for the accuracy and precision of gas chromatography-based monitoring systems used to measure pollutant concentrations in industrial emissions.

As discussed elsewhere herein, determining the geolocation of a flow device 26, 28 can be useful in several regards. In examples there is a flow device 26, 28 where the one or more processors are configured to perform functions that relate to determining a geolocation of the flow device 26, 28. For instance, the one or more processors can be configured to determine a geolocation of the source or sink using GPS, IP addresses, or the like. In examples, this determination can occur automatically and without user intervention. In this regard, the flow device 26, 28 can execute a gatekeeping measure to inhibit geolocation tampering using the geolocation. The determined geolocation can be compiled into a database for logging geolocations of at least one of sources and sinks. This database can be local or remote to the flow device 26, 28. In examples, the one or more processors can reference the database. In effect, the flow device 26, 28 can itself generate or facilitate a remote system to generate a database of sources and sinks. This feature can help solve the problem of Implementations of the described techniques may include hardware, a method or process, or a computer tangible medium.

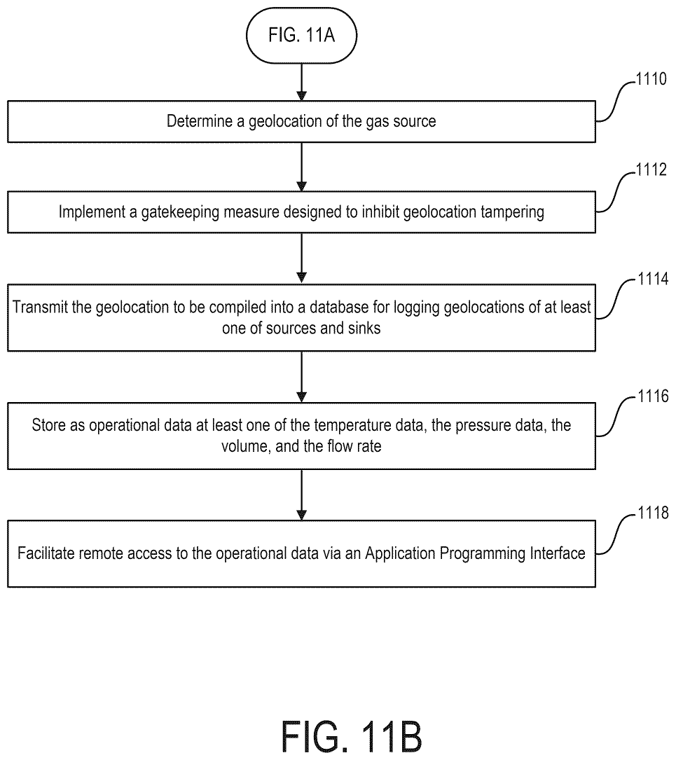

FIG. 11 is a flow chart of a method 1100, according to an example of the present disclosure. Such a method can be for quantifying emissions concentrations emitted from a gas source via a flow path at which a sensor assembly is arranged.

According to an example, one or more method blocks of FIG. 11 may be performed by devices and systems disclosed herein. As shown in FIG. 11, method 1100 may include obtaining temperature data and pressure data corresponding to a gas emitted by the gas source (block 1102). For example, device may obtain temperature data and pressure data corresponding to a gas emitted by the gas source, as described above. As in addition shown in FIG. 11, method 1100 may include obtaining indicia of whether there has been a barometric change at either the gas source or the sensor assembly (block 1104). For example, device may obtain indicia of whether there has been a barometric change at either the gas source or the sensor assembly, as described above. As also shown in FIG. 11, method 1100 may include adjusting, if there is a barometric change, the pressure data to account for the barometric change (block 1106). For example, device may adjust, if there is a barometric change, the pressure data to account for the barometric change, as described above. As further shown in FIG. 11, method 1100 may include determining a flow rate of gas emitted by the gas source, a proportion of an emissions present in the gas emitted from the gas source, and a flow rate or volume of the emissions being released based on the pressure data and the temperature data (block 1108). For example, device may determine a flow rate of gas emitted by the gas source, a proportion of an emissions present in the gas emitted from the gas source, and a flow rate or volume of the emissions being released based on the pressure data and the temperature data, as described above.

Method 1100 may include additional implementations, such as any single implementation or any combination of implementations described below and/or in connection with one or more other methods described elsewhere herein. In a first implementation, determining the flow rate or the volume of emissions includes determining both volumetric and mass flow rates.

In a second implementation, alone or in combination with the first implementation, the temperature data includes data corresponding to an absolute temperature at flow conditions and an absolute temperature at standard conditions, and where the pressure data includes data corresponding to an absolute pressure at flow conditions, an absolute pressure at standard conditions, and a pressure drop at the gas source.

A third implementation, alone or in combination with the first and second implementation, method 1100 may include determining a geolocation of the gas source (block 1110).

In a fourth implementation, alone or in combination with one or more of the first through third implementations, determining the geolocation of the gas source occurs automatically as part of a gatekeeping measure designed to inhibit geolocation tampering (block 1112).

A fifth implementation, alone or in combination with one or more of the first through fourth implementations, method 1100 may include transmitting the geolocation to be compiled into a database for logging geolocations of at least one of sources and sinks (block 1114).

A sixth implementation, alone or in combination with one or more of the first through fifth implementations, method 1100 further includes storing as operational data at least one of the temperature data, the pressure data, the volume, and the flow rate; (block 1116) and facilitating remote access to the operational data via an Application Programming Interface (block 1118).

In a seventh implementation, alone or in combination with one or more of the first through sixth implementations, the quantification occurs in real time.

It should be noted that while FIG. 11 shows example blocks of method 1100, in some implementations, method 1100 may include additional blocks, fewer blocks, different blocks, or differently arranged blocks than those depicted in FIG. 11. Additionally, or alternatively, two or more of the blocks of method 1100 may be performed in parallel.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

Although certain embodiments above have been described with reference to their use to monitor and/or convert methane released from a gas or oil well or certain other specifically described methane sources, other embodiments have application in other contexts. For example, landfills and other sources of decomposing organic matter (e.g., manure) may generate appreciable amounts of methane, and some embodiments could be used in such contexts to monitor, quantify and/or convert methane as described herein.

What is claimed is:

1. A method of quantifying emissions concentrations emitted from a gas source via a flow path at which a sensor assembly is arranged, the method comprising:
obtaining temperature data and pressure data corresponding to a gas emitted by the gas source;
obtaining indicia of whether there has been a barometric change at either the gas source or the sensor assembly;
adjusting, if there is a barometric change, the pressure data to account for the barometric change; and
determining a flow rate of gas emitted by the gas source, a proportion of an emissions present in the gas emitted from the gas source, and a flow rate or volume of the emissions being released based on the pressure data and the temperature data.

2. The method of claim 1, wherein determining the flow rate or the volume of emissions includes determining both volumetric and mass flow rates.

3. The method of claim 1, wherein the temperature data includes data corresponding to an absolute temperature at flow conditions and an absolute temperature at standard conditions, and wherein the pressure data includes data corresponding to an absolute pressure at flow conditions, an absolute pressure at standard conditions, and a pressure drop at the gas source.

4. The method of claim 1, further comprising determining a geolocation of the gas source.

5. The method of claim 4, wherein determining the geolocation of the gas source occurs automatically as part of a gatekeeping measure designed to inhibit geolocation tampering.

6. The method of claim 4, further comprising transmitting the geolocation to be compiled into a database for logging geolocations of at least one of sources and sinks.

7. The method of claim 1, further comprising:
storing as operational data at least one of the temperature data, the pressure data, the volume, and the flow rate; and
facilitating remote access to the operational data via an Application Programming Interface.

8. The method of claim 1, wherein the quantification occurs in real time.

9. A system for compiling a database of geolocations of sources and sinks, the system being configured to acquire a geolocation of a source or sink as determined by a flow device that is configured to quantify emissions concentrations emitted from a gas source via a flow path, wherein acquiring the geolocation of the sources or the sinks as determined by the flow device acts as part of a gatekeeping measure to inhibit tampering with the geolocation.

10. The system of claim 9, wherein the flow device is remote from the system.

11. The system of claim 9, wherein the system further comprises a storage to store as operational data that is measured by the flow device at least one of temperature data, pressure data, volume, and flow rates, the system is further configured to facilitate remote access to the operational data via an Application Programming Interface (API).

12. The system of claim 11, wherein the API enables connectivity to validate the quantification.

13. The system of claim 9, wherein the flow device is configured to quantify the emissions concentrations emitted from a gas source via the flow path while accounting for barometric changes at the flow device.

14. The system of claim 9, wherein the quantification occurs in about 140 milliseconds to capture low-end bubble flow.

15. A flow device for portably quantifying emissions concentrations in a gas flow at a source, the flow device comprising:
a flow path through which gas is transmitted from the source flows, the flow path including a flow path inlet and a flow path outlet;
a sensor assembly configured to measure a temperature at the flow device, a pressure drop between the flow path inlet and the flow path outlet, an absolute pressure at the flow device, and a barometric pressure; and
one or more processors in communication with the sensor assembly, the one or more processors configured to:
adjust the pressure drop to generate a corrected pressure drop based on the barometric pressure if there has been a barometric change and based on a previous barometric pressure if there has not been a barometric change;
calculate a mass flow rate of the gas flow using the temperature, the corrected pressure drop, and the absolute pressure; and
quantify an amount of the emissions concentrations in the gas flow as a proportion of the gas flow using the mass flow rate.

16. The flow device of claim 15, wherein the one or more processors is further configured to calculate a volumetric flow rate from a Poiseuille equation using the corrected pressure drop, and wherein the mass flow rate is calculated using the temperature, the volumetric flow rate, and the absolute pressure.

17. The flow device of claim 16, further comprising a storage for storing as operational data determined by the flow device at least one of temperature data, pressure data, volume, the mass flow rate, and the volumetric flow rate, and wherein the one or more processors is further configured to facilitate remote access to the operational data via an Application Programming Interface (API).

18. The flow device of claim 17, wherein the API enables connectivity to validate the quantification and to calculate carbon credits based on the quantification.

19. The flow device of claim 15, wherein the sensor assembly includes a gas chromatography detector arranged upstream of the flow path.

20. The flow device of claim 15, wherein the one or more processors are further configured to:
determine, automatically and without user intervention, a geolocation of the source;
execute a gatekeeping measure to inhibit geolocation tampering using the geolocation; and
compile the geolocation into a database of the flow device for logging geolocations of sources.
